(19) United States
(12) Patent Application Publication
(10) Pub. No.: US 2026/0120898 A1
(43) Pub. Date: Apr. 30, 2026

(54) SEISMIC ISOLATION SYSTEM

(71) Applicant: TerraPower, LLC, Bellevue, WA (US)

(72) Inventors: Dylan Addison, Corvallis, OR (US); Michael Cohen, Seattle, WA (US); Alon Katz, Redmond, WA (US); Tamas Liszkai, Terrebonne, OR (US); Edward Han, Wilmington, NC (US); Jay Perry, Wilmington, NC (US)

(21) Appl. No.: 19/060,545

(22) Filed: Feb. 21, 2025

Related U.S. Application Data
(60) Provisional application No. 63/637,361, filed on Apr. 22, 2024.

(51) Int. Cl. G21C 9/00

(52) U.S. Cl. CPC G21C 9/00

(57) ABSTRACT

A nuclear reactor must be designed and constructed to withstand seismic events. A modular integrated reactor support structure includes seismic isolators that rely on viscous dampers and elastic support assemblies to provide three-dimensional seismic isolation to the reactor head, reactor vessel and reactor internal components. The gravitational load of the reactor head, reactor vessel, and reactor internals is supported through the reactor head, which transfers the load to a plurality of seismic isolators, which in turn, transfer the load to the basemat of the reactor building. A plurality of reactor support assembly blocks couple the reactor head to the seismic isolators while permitting thermal expansion and contraction of the reactor head while limiting rotational motion.

### CROSS REFERENCE

The present application claims the benefit of, and priority to, U.S. Provisional Patent Application No. 63/637,361, filed Apr. 22, 2024, titled “SEISMIC ISOLATION SYSTEM,” the entire contents of which is hereby incorporated by reference.

### GOVERNMENT LICENSE RIGHTS

This invention was made with government support under DOE Cooperative Agreement No. DE-NE0009054 awarded by the U.S. Department of Energy. The government has certain rights in the invention.

### FIELD OF THE DISCLOSURE

This disclosure is directed to a seismic isolation system, and more specifically, to seismic isolators and modular supports for a nuclear reactor.

### BACKGROUND

Nuclear plants are typically designed and built to withstand earthquakes and other natural hazards. Regulatory agencies publish design, operation, and maintenance requirements for a nuclear plant's safety-significant structures, systems, and components. In many cases, safety margins are built into the design and construction of the safety-significant structure to ensure that the most critical systems are able to survive even the worst natural disaster scenario.

With respect to earthquakes, many regulatory agencies require that safety related systems are designed to withstand the most severe natural phenomena historically reported for the site and surrounding area in which a nuclear plant is to be constructed. The design of such systems is further influenced by the importance of the safety functions of the structures, systems, and components.

The result is that safety-related systems are typically over engineered and built well above the design criteria to ensure that such systems can continue to function even after experiencing a significant seismic event. Moreover, the design and engineering of the safety-significant structures relies on an impressive volume of concrete to meet the structural, seismic, and shielding requirements.

This tendency to design structures, systems, and components to a design factor that is far in excess of what is required results in inefficiencies and increased costs. It would be advantageous and much more efficient if structures, systems, and components were designed to an appropriate degree of seismic resistance especially in light of increasing knowledge about seismic events while reducing the required volume of concrete in order to meet the regulatory seismic safety guidelines.

In many currently proposed nuclear reactors, they are designed to operate at lower pressures than typical light water reactors, and even near ambient pressure. Therefore, many of the structures, systems, and components need not be designed to withstand high pressures, but rather, may be designed to be less robust, which may exacerbate the issues arising from induced stresses cause by natural phenomena, such as seismic events.

Most nuclear reactors have a core within which fuel elements and control elements are supported in different interrelated arrangements to support a critical reactivity to control the output of the reactor. Coolant is typically forced through passages between fuel elements and control elements to transfer heat generated by fissioning fuel elements to a heat exchanger to be used for useful purposes.

In some cases, molten metal is used as the coolant, which in some cases, is sodium. In some nuclear reactors, such as in a pool type reactor in which the core is submerged in a pool of coolant held within a reactor vessel, the core is often supported by the reactor vessel while the control elements are often supported from a deck of the vessel head that encloses the top of the reactor vessel.

This control element support arrangement is often preferable from a safety standpoint. For example, if the control element support structures were to fail, the control elements would fall into the reactor vessel and reduce reactivity within the core. Typically, the weight of the core is supported by the reactor vessel, as is the in-vessel handling system for the fuel elements and reactivity elements along with the fuel elements and reactivity elements.

In addition to the weight of the core, the vessel also supports the weight of the coolant contained therein. The vessel must therefore be robust in order to support the applied loads not only in static conditions but must also be able to support the loads during seismic events, which can apply dramatically greater loads than in a static condition.

Moreover, any relative motion between the reactor core and the control elements can impact the reactivity within the core, and thus, reactors are designed to minimize relative motion between the core and control elements. If a reactor vessel is supported from the side or its bottom and the coolant inventory is brought into motion, such as by a seismic event, the flexibility of the reactor vessel can allow the reactor core to move relative to the control elements suspended from the vessel head, thus causing swings in a reactivity coefficient (Keff) in both positive and negative reactivity directions.

It would therefore be advantageous to account for, or even reduce, the relative motion between the reactor vessel, the core, and the control elements. These, and other advantages, will become apparent by reference to the following disclosure and accompanying figures.

### SUMMARY

According to some embodiments, a seismically isolated nuclear reactor includes a reactor head; a reactor vessel coupled to, and hanging from, the reactor head; a reactor support coupled to a periphery of the reactor head; a plurality of seismic isolators located under the reactor support, and further coupled to a basemat of a reactor building, wherein the plurality of seismic isolators are configured to cooperate to isolate the reactor head from seismic events.

The reactor support may include a plurality of arc-shaped components that are coupled to form a ring around the reactor head. The arc-shaped components may be welded together to form the ring that provides support for the reactor head. In some cases, at least some of the plurality of seismic isolators comprise viscous dampers. In addition, some of the plurality of seismic isolators may comprise spring loaded assemblies. In some cases, at least some of the plurality of seismic isolators have both viscous dampers and spring-loaded assemblies. In some cases, the seismic isolators are configured to provide three-dimensional seismic isolation to the nuclear reactor.

The nuclear reactor may further include a plurality of support blocks, where each of the support blocks is coupled to the reactor support and engages with the reactor head. The support blocks may be configured to secure the reactor head to the support blocks. In some examples, the plurality of support blocks includes a bearing plate upon which the reactor head rests. The support blocks may further include a cylindrical bearing configured to allow thermal expansion of the reactor head.

In some instances, interfering structure is coupled to the reactor head, the interfering structure positioned such that it is disposed on both sides of a support block when the support block is engaged with the reactor head, the interfering structure configured to limit rotation motion of the reactor head relative to the support blocks. For instance, gussets or some other type of protrusion from the reactor head may be disposed on either side of a support block, and as the reactor head tries to rotate, the gussets contact the support block which impedes further rotation of the reactor head.

In some examples, the reactor support comprises a plurality of modular supports configured to be coupled together to form a ring around the reactor vessel and reactor head. The reactor support may further include a port configured to allow ambient air to pass through the reactor support to provide cooling air to an outside surface of the nuclear reactor. In some embodiments, the reactor support further includes hollow chambers disposed vertically downward from the ring. The hollow chambers may be configured to carry radiation shielding material. For instance, the hollow chambers may be filled with concrete, such as non-structural concrete that provides an additional radiation barrier.

In some cases, a load path of the reactor vessel (e.g., the weight of the reactor head, reactor vessel, and reactor internals) is transferred to the reactor head, and then to the reactor support, and then to the seismic isolators, and then to the basemat of the reactor building.

In this way, the entirety of the reactor vessel and all its internals is supported by the reactor head, which is supported by the reactor support, which is coupled to the reactor building basemat by seismic isolators.

According to some embodiments, a modular reactor seismic system includes a support block having an upper section and a lower section and a gap sized to capture a reactor head of a nuclear reactor therein, the support block having a lower surface; a support structure coupled to a lower surface of the support block, the support structure having an arc-shape and configured to extend at least partially around a circumference of the reactor head; and a three-dimensional seismic isolator located under at least a portion of the support structure, the three-dimensional seismic isolator coupled to the support structure and further coupled to a floor and configured to attenuate and dissipate motion of the floor.

The support structure may be coupled to a plurality of adjacent support structures such that the plurality of adjacent support structures forms a ring. The ring may be sized and shaped to circumscribe a nuclear reactor head and/or a reactor guard vessel and/or a reactor vessel.

In some cases, a plurality of the support blocks is coupled to the ring. For instance, a plurality of support blocks may be evenly spaced around and on top of the ring to provide a secure connection to a reactor head, a reactor guard vessel, and/or a reactor vessel.

In some examples, a plurality of the seismic isolators is positioned underneath the ring and configured to support the weight of the ring. The plurality of seismic isolators may be positioned at regular intervals around the ring. In some cases, the three-dimensional seismic isolators include a viscous damper and an elastic support assembly. Of course, some seismic isolators may only include either a viscous damper or an elastic support assembly.

### BRIEF DESCRIPTION OF THE DRAWINGS

FIG. 1 illustrates a sample architecture of a reactor building, in accordance with some embodiments;

FIG. 2A illustrates a partial cutaway view of a nuclear reactor, showing the reactor vessel, and some of the internal components, in accordance with some embodiments;

FIG. 2B illustrates a view of a seismic isolator, in accordance with some embodiments;

FIG. 3 illustrates a cutaway view of the reactor enclosure system showing the reactor internals and the load path for the reactor, in accordance with some embodiments;

FIG. 4 illustrates a partial cutaway view showing the nuclear reactor and its mounting configuration, in accordance with some embodiments;

FIG. 5 illustrates a viscous damper assembly of the seismic isolation system, in accordance with some embodiments;

FIG. 6 illustrates an example seismic isolator incorporating both a viscous damper and an elastic support assembly, in accordance with some embodiments;

FIGS. 7A-7C illustrate an example reactor support assembly block for a seismic isolation system, in accordance with some embodiments;

FIG. 8 illustrates a component of a modular reactor support structure, in accordance with some embodiments; and

FIG. 9 illustrates a view of some of the components for a modular reactor support structure including an air-cooling port, in accordance with some embodiments.

FIG. 10A illustrates a partial cutaway view showing the nuclear reactor and its mounting configuration, in accordance with some embodiments;

FIG. 10B illustrates a closeup view of some of the components for a modular reactor support structure including an air-cooling port, in accordance with some embodiments;

FIG. 11A illustrates a cross-sectional view of the reactor building and a nuclear reactor enclosure system, and the seismic isolation system supporting the nuclear reactor; in accordance with some embodiments;

FIG. 11B illustrates a close-up view of the reactor support block, in accordance with some embodiments;

FIG. 11C illustrates a close-up view of the seal between the reactor vessel and the guard vessel, in accordance with some embodiments.

### DETAILED DESCRIPTION

This disclosure generally relates to methods and systems for isolating a nuclear reactor from seismic loads. Historically, structures and buildings are designed to accommodate seismic loads in a horizontal direction, such as by using dampers, springs, rollers, or a combination. One of the advantages of the systems and methods described herein is the ability to accommodate three-dimensional displacement from seismic events.

An earthquake's energy spreads out from the fault and moves the ground. The velocity and magnitude of the movement is dependent on how the seismic event releases energy and how the soil absorbs or dissipates the energy. Earthquakes are measured in terms of frequency and magnitude, which affect a nuclear plant's buildings and the systems, structures, and components (SSCs) within the buildings, and the resulting acceleration forces are measured in terms of the earth's gravity, expressed in g's.

Currently, nuclear regulatory agencies promulgate generally accepted criteria for designing a nuclear plant so that an earthquake motion at the site will not jeopardize the safety of the plant. According to published and accepted siting criteria, following definitions of terms relate to those terms used herein:

### Definitions

The magnitude of an earthquake is a measure of the size of an earthquake and is related to the energy released in the form of seismic waves. Magnitude means the numerical value on a Richter scale.

The intensity of an earthquake is a measure of its effects on man, on man-built structures, and on the earth's surface at a particular location. Intensity means the numerical value on the Modified Mercalli scale.

The Safe Shutdown Earthquake is an earthquake which is based upon an evaluation of the maximum earthquake potential considering the regional and local geology and seismology and specific characteristics of local subsurface material. It is an earthquake which produces the maximum vibratory ground motion for which certain safety-related structures, systems, and components are designed to remain functional. These structures, systems, and components are those necessary to assure: (1) the integrity of the reactor coolant pressure boundary, (2) the capability to shut down the reactor and maintain it in a safe shutdown condition, or (3) the capability to prevent or mitigate the consequences of accidents which could result in potential offsite exposures.

The Operating Basis Earthquake is an earthquake which, considering the regional and local geology and seismology and specific characteristics of local subsurface material, could reasonably be expected to affect the plant site during the operating life of the plant; it is that earthquake which produces the vibratory ground motion for which those features of the nuclear power plant necessary for continued operation without undue risk to the health and safety of the public are designed to remain functional.

A fault is a tectonic structure along which differential slippage of the adjacent earth materials has occurred parallel to the fracture plane. It is distinct from other types of ground disruptions such as landslides, fissures, and craters. A fault may have gouge or breccia between its two walls and includes any associated monoclinal flexure or other similar geologic structural feature.

Surface faulting is differential ground displacement at or near the surface caused directly by fault movement and is distinct from nontectonic types of ground disruptions, such as landslides, fissures, and craters.

A capable fault is a fault which has exhibited one or more of the following characteristics: (1) movement at or near the ground surface at least once within the past 35,000 years or movement of a recurring nature within the past 500,000 years, (2) macro-seismicity instrumentally determined with records of sufficient precision to demonstrate a direct relationship with the fault or (3) a structural relationship to a capable fault such that movement on one could be reasonably expected to be accompanied by movement on the other.

Regulatory authorities mandate significant geologic, seismic, and engineering characteristics of a proposed site and its environs in order to provide reasonable assurance that they are sufficiently well understood to permit adequate evaluation of the proposed site and to provide sufficient information to support the determination and engineering solutions to actual or potential geologic and seismic effects at the proposed site.

Published seismic design criteria (SDC) defines the seismic design basis (SDB) for each SSC. The SDC is generally a function of location, building occupancy, and soil type. Building performance during a seismic event depends on both the severity of subsurface rock motion and the type of soil upon which a structure is constructed. In generally, SDCs specify the probability levels for design base earthquakes and structural performance. SDCs typically range from a category of “1” for conventional buildings to “5” for more hazardous facilities such as some of the buildings situated within a nuclear plant.

For example, SSCs are designated SDC-1 if the consequences of SSC failure place facility workers at risk of physical injury not related to radiological or toxicological release. SSCs are designated SDC-2 if the consequences of SSC failure may place facility workers at risk of physical injury or may adversely affect facility emergency operations. SSCs are designated SDC-3 if the radiological or toxicological consequences of SSC failure may require activation of emergency plans to ensure public protection or if there is a potential for long-term health effects for the facility worker. SSCs are designated SDC-4 if the radiological or toxicological consequences of SSC failure may result in long-term health effects or fatality for the facility worker. SSCs are designate SDC-5 if radiological or toxicological consequences of SSC failure are likely to result in worker fatality.

A significant analysis of nuclear reactor plan design is spent on safety, and appropriately categorizing the SSCs to ensure that design criteria are appropriately applied and met to ensure the safety of the facility workers and the public from any unmitigated consequences of SSC failure. According to some nuclear power plant installations, a construction site may be prepared by removing soil to an appropriate depth, such as up to 70 feet or more. In some cases, the excavated area is backfilled with structural backfill soil, that is compacted to meet density requirements. The density of the compacted backfill alleviates the phenomena of liquefaction, the process by which water-saturated sediments transform from a solid into a flow liquid-like substance during an earthquake. It is the liquefaction of the soil that is primarily responsible for undermining the foundation of buildings during a seismic event. In many cases, nuclear reactor buildings and auxiliary buildings are surface sited once the underlying soil has been adequately prepared.

The idea of constructing nuclear power plants underground is not new, with a host of research performed in the late 1950s and 1960s. In fact, at least four small nuclear power plants were built in Europe in rock cavities, with safety as a primary motivator for constructing plants underground. Since then, the interest in underground siting have been decreasing as people have become more comfortable with the ability to contain consequences of conceivable accidents within acceptable limits. Moreover, a surface site is more efficient for power transmission, provides more unfettered access for construction, and is the least expensive construction method. However, surface siting relies heavily on nuclear structural concrete to provide the structure and shielding necessary to protect the nuclear plant from external hazards as well as internal hazards. According to some estimates, with respect to past construction of light water reactors (LWR) the concrete requirement is on the order of 50 m³/MWe or more.

Surface sited nuclear plants require a considerable amount of nuclear seismic concrete in order to meet seismic requirements. The production of Portland cement, which is typically used in concrete, is responsible for 8% of the anthropogenic CO₂ emission in the world and is quickly rising as the demand for concrete continues to increase. While a nuclear plant generally operates with a 0% carbon emission, the construction of a nuclear site results in a considerable amount of green-house gas emissions, primarily from the concrete required for construction.

While buildings may be designed and built to withstand seismic events, such as by accommodating lateral movement in a horizontal plane, a nuclear reactor, especially one operating in a fast neutron spectrum, is sensitive to seismic loads and in order to improve safety, maintain a predictable reactivity, and protect the sensitive core components, a nuclear reactor should be configured with a seismic isolation system (SIS) able to accommodate three-dimensional loads.

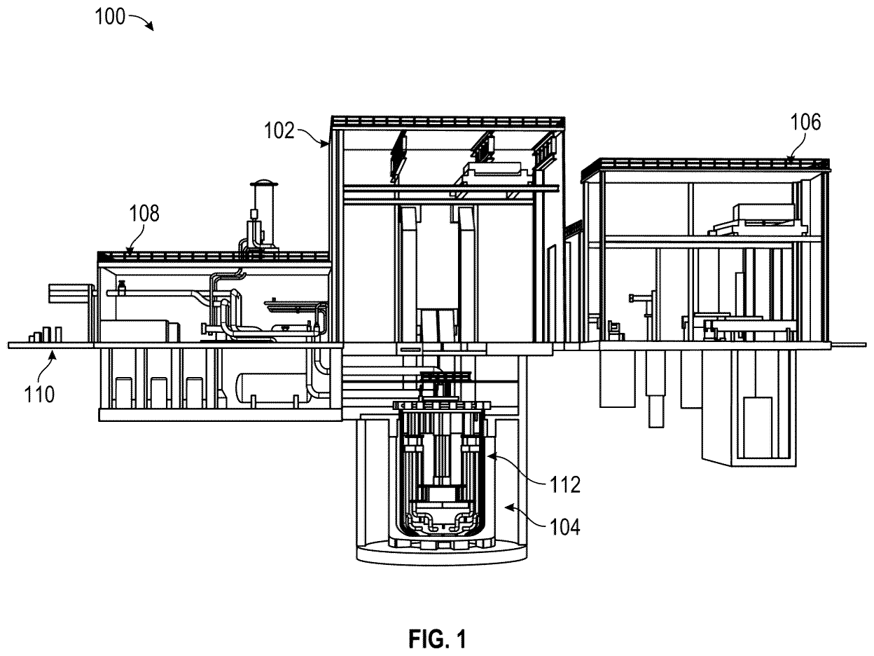

FIG. 1 illustrates an example nuclear island 100 at a nuclear reactor installation showing the reactor building 102 and the below grade nuclear reactor 104. Additional buildings may be a part of the nuclear island, such as a fuel handling building 106 a reactor auxiliary building 108 among others. In some cases, the buildings may be built on grade 110, and/or may have portions thereof that are constructed below grade 110.

The reactor building 102 typically serves as the center point of the nuclear island and may be located between the fuel handling building 106 and the reactor auxiliary building 108, as illustrated. In some embodiments, the reactor building 102 houses safety significant systems including the reactor enclosure system 112 (RES) which contains the nuclear core, sodium cover gas system and supports the duct and stacks for the passive emergency reactor air cooling system (RAC). In some examples, the RES comprises the reactor vessel and the guard vessel, which provide independent and redundant systems for radioactive material containment.

According to some embodiments, some of the advantages of below grade construction can be realized by incorporating a mixed installation where some of the structures are below ground and some structures are surface built. In addition, the structure location can be determined, at least in part, by the seismic category. Furthermore, the structures may be seismically decoupled, such that a seismic event affecting one structure does not affect other structures.

However, according to some embodiments, rather than seismically isolating entire buildings, which is the strategy in most previous reactor installations, only certain equipment may be seismically isolated to ensure the safety of the isolated equipment. This strategy is becoming more important as newer reactor technologies do not require high pressures, and therefore, do not require robust containment typically provided by inches or feet-thick reinforced concrete structures to accommodate a beyond design basis event (BDBE). For example, in many newer reactor designs, the operating pressures are near ambient, which may only require a steel building in order to withstand a BDBE.

In many of the embodiments described herein, a sodium-cooled fast reactor (SFR) is used as an exemplary reactor technology. It should be understood that the concepts described herein may be applicable to many other reactor technologies and the embodiments described herein should not be limited to an SFR design or implementation. Furthermore, the seismic isolations systems described herein may be applied to other critical components and equipment of a nuclear reactor, which is a stark departure from historical nuclear reactor installation that require entire building to be protected against seismic events rather than only protecting the equipment and components.

However, for efficiency of description, an SFR is used as an example. Generally, an SFR is a pool-type advanced sodium fast reactor in which the design employes a relatively small containment envelope when compared to traditional light water reactors (LWRs). In many cases, the radioactive primary sodium coolant and argon cover-gas are housed within steel vessels—the reactor vessel (RV) and a guard vessel (GV) that surrounds the RV. The RV typically houses the core, core supports and much of the major equipment that supports the primary heat transport loop, including an intermediate heat exchanger(s) (IHX) and the primary sodium pump(s) (PSP). The GV surrounds the RV and may be relied upon as secondary containment and defense in depth in case of an unlikely event of a reactor vessel boundary fault. In some cases, the RES interfaces with the reactor building 102 through a seismic isolation system SIS.

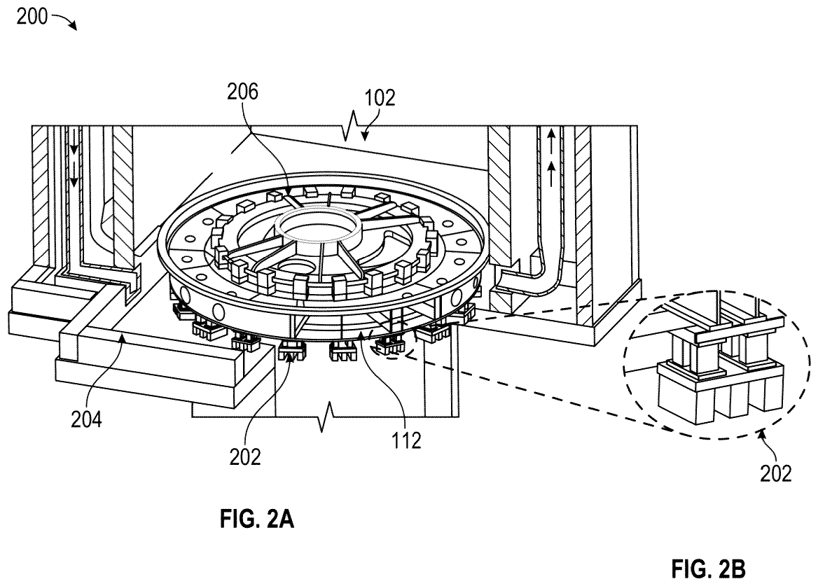

FIGS. 2A and 2B illustrate a seismic isolation system 200 at the interface between the RES 112 and the reactor building 102. More specifically, the SIS may include a plurality of individual SIS assemblies 202. In some cases, there may be between 8-96, or between 10-72, or between 12-54, or between 18-36 individual SIS assemblies 202 that cooperate to support the RES 112. The SIS assemblies 202 may include one or more components that provide both lateral and vertical support (e.g., three-dimensional (3D) seismic isolation). In some examples, the 3D seismic isolation may be provided by one or more of springs and dampers. In some cases, the springs may be helical, and the dampers may be viscous dampers. In those embodiments that utilize helical springs, the response may be approximated as linear over a broad range of deflections and with little coupling between the horizontal and vertical stiffness values. The spring assemblies and viscous dampers may be connected in parallel and work to dissipate energy from the system as well as attenuate the amplitude of the response to the seismic motions. In some cases, the SIS assemblies 202 are arranged in a circular pattern around the RES and may interface with the reactor building, such as at a basemat 204 positioned on a floor of the reactor building.

In some examples, the reactor building basemat 204 may be a cast in place reinforced concrete foundation, which is some cases is upwards of six feet thick and is designed to support the nuclear island structures, such as the RES 112. In some cases, the basemat 204 may be considered as the foundation of the building. In some examples, the RES 112 is supported by the reactor head (RH) 206, and the reactor head 206 is supported on the basemat 204 while the RES 112 hangs from the reactor head 206.

In some instances, viscous dampers include a damper housing, a fluid container (which may be either pressurized or non-pressurized), and viscous damper fluid and piston immersed in the damper fluid. The housing and the piston may be attached to base plates which in turn provide the load transfer to the supported and isolated structures. The piston of an individual damper assembly may move with six degrees of freedom. For example, the piston may be able to translate in x, y, and z directions, and additionally rotate about x, y, and z axes. Therefore, when the viscous dampers are arranged in a circular pattern, as illustrated, they provide damping and energy dissipation in all three translational directions. In some cases, the dampers may be a passive safety system and require no power or control in order to perform their function. In some cases where the damper-fluid containing chamber is not pressurized, they do not require seals. In addition, there need not be any control valves or adjustable orifices to set the operational range of the damper that needs to be calibrated or adjusted periodically. The result is a damper assembly that is truly passive requiring little to no maintenance in order to perform its safety function over the lifetime of the nuclear reactor.

As further illustrated in FIGS. 2A and 2B, the supported equipment includes the reactor core and primary sodium coolant inventory, which are both contained within the reactor vessel, which is a part of the RES 112. In some examples, the RES 112 is divided into multiple subsystems that may all be located in, and are either directly or indirectly supported by, the SIS 202 and the reactor building 102. The reactor vessel, along with the reactor head 206 and the IHX tube bundles form most of the reactor primary coolant and cover gas boundaries. The reactor head 206 additionally supports equipment interfacing with the core and primary coolant. The reactor head 206 and reactor vessel provides support for the reactor internals and the core support, which in turn, supports the reactor core.

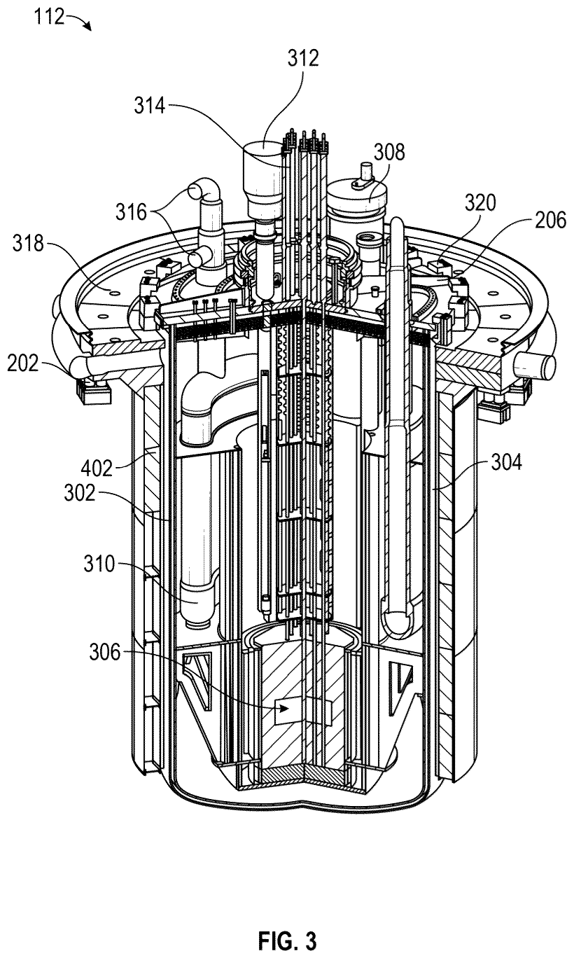

FIG. 3 illustrates a schematic cutaway view of the reactor vessel, guard vessel, and the components supported thereby. Notably, FIG. 3 illustrates many of the components that are seismically isolated by the SIS 202. The reactor vessel 302 is a sealed vessel that holds the inventory of primary coolant. It is surrounded by the guard vessel 304 that provides a depth in defense containment for the primary coolant. Some of the primary components within the reactor vessel 302 include the reactor core 306 that includes core assemblies, which may include fertile and/or fissionable fuel assemblies, as well as neutron absorbers, reflectors, shields, among other core assemblies. One or more primary sodium pumps 308 circulate the primary sodium coolant throughout the reactor vessel, upwardly through the core and through the intermediate heat exchangers 310.

The reactor head 206 includes penetrations to accommodate components that are located both within and without the reactor, such as, for example, an in-vessel transfer machine (IVTM) 312 that allows the insertion, removal, and shuffling of core assemblies; the control rod drive mechanism 314 that drives the control rods into or out of the core 306; intermediate coolant flow conduits 316 that allow hot and cold intermediate coolant to flow through the intermedia heat exchangers 310, along with instrumentation and other components.

As illustrated, in some embodiments, the reactor head 206 is coupled to a modular integrated reactor support system (MIRSS) 318 by way of reactor support assembly blocks 320. The MIRSS 318 may be formed of modular pieces that are assembled together and coupled to the reactor head 206. In some cases, the MIRSS 318 include a plurality of modular components that are generally arc-shaped and assemble to form a ring around the reactor head 206. The MIRSS may therefore comprise 6, 9, 12, 18, 20, 24, 30, 36, 40, or 60 individual modular components that may be assembled to encompass the periphery of the reactor head 206. In some cases, the MIRSS 318 comprises 20 components that are coupled to the reactor head 206 to provide support to the reactor head and to transfer the load of the reactor head to the basemat of the reactor building.

The MIRSS components may be fabricated in a manufacturing facility, shipped to the installation site, and assembled on site to provide the support and load transfer required. In some examples, the MIRSS components 318 may be welded together on site. Similarly, the reactor support assembly blocks 320 may likewise be fabricated in a manufacturing facility and may alternatively be coupled to the MIRSS component in the manufacturing facility, or once delivered to the construction site. The reactor support assembly blocks 320 may be welded to the MIRSS components and may be provided such that each MIRSS component 318 includes one reactor support assembly block 320. Of course, not all embodiments require parity between the MIRSS components 318 and reactor support assembly block 320, as a single MIRSS component 318 may include more than, or fewer than, one reactor support assembly block 320. In some cases, the reactor support assembly blocks 320 may be provided across the joint between adjacent MIRSS components 318 and may help to strengthen the coupling between adjacent MIRSS components 318.

The MIRSS components 318 may be coupled to one or more seismic isolators 202. For instance, one or more seismic isolators 202 may be provided to support the weight of the MIRSS components 318. In some cases, each of the MIRSS components 318 may include one or more seismic isolators 202. The seismic isolators 202 may be coupled to the MIRSS components 318 through any suitable connection, which may include, without limitation, welding, bolting, a keyed connection, a boss and pocket, or some other suitable mechanical connection.

Through the seismic isolators 202, the load path of the MIRSS components 318, the reactor head 206, the RV 302 and GV 304 along with all the components supported within the RV 302 are transferred through the seismic isolators 202 and to the basemat of the reactor building. Consequently, any seismic motion that may be transferred to the reactor building and basemat is largely attenuated and dissipated by the seismic isolators 202, and only a small portion of the seismic motion may ultimately reach the reactor. Moreover, the reactor components that are sensitive to relative motion, such as the fuel assemblies, primary coolant inventory, and other core assemblies are all commonly supported by the reactor head, and therefore will all move concurrently thus reducing or elimination any relative motion between these sensitive components.

Thus, the RES is seismically isolated from the supporting reactor building basement using 3D SIS technology as described herein, which will be further described hereinafter. The seismic isolators 202 are mounted to the basemat using any suitable method, which in some cases, relies on embeds from below, and provides support for the MIRSS components 318 resting thereon. In some cases, the MIRSS components 318 are a plate-girder steel structure which supports the RES on its inner diameter ledge through the reactor support blocks 320. In this way, the MIRSS components 318, along with the reactor support blocks 320, constrain the reactor head 206 such that a stiff load-path from the reactor head 206 to the seismic isolators 202 is formed, while accommodating the relative thermal growth of the reactor head 206 and the basemat.

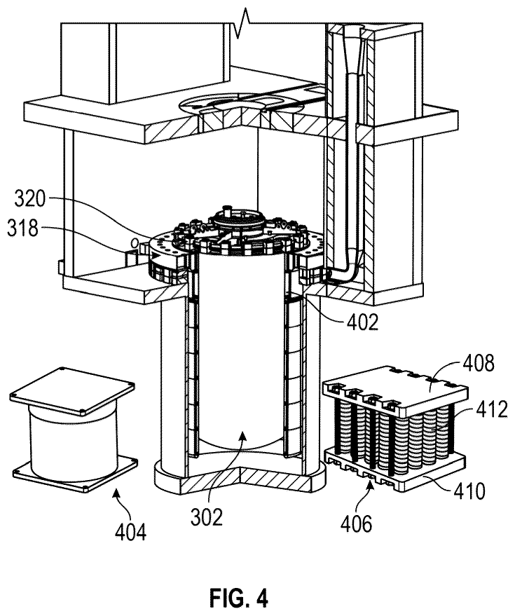

FIG. 4 further illustrates the seismic isolators 202 along with provided air cooling to the reactor. The MIRSS components 318 may also support a collector cylinder 402, which extends downward around the reactor and may support the air-cooling function. In some cases, cold air ducts direct incoming air down the outside surface of the collector cylinder 402, where the air then reverses direction, flowing up around the outside of the reactor and out the hot ducts. In some instances, the collector cylinder 402 provides an annular space around the guard vessel, which may be filled, or partially filled, with shielding material to provide additional shielding around the reactor vessel. Concrete may be used as a shielding material, which may be non-structural concrete since it is note required for strength or rigidity. Of course, other shielding materials may be inserted into the collector cylinder 402, which may be liquid material, solid material, or a combination of materials.

The seismic isolators 202 are, in some cases, sized and calibrated for attenuation of seismic loads and to support the RES during normal and off-normal conditions. In some cases, there may be up to 36 or more seismic isolators 202 spaced around the MIRSS 318.

In some embodiments, the seismic isolators 202 are formed of one or more seismic isolation viscous dampers 404 and one or more seismic isolation elastic support assemblies 406. In some cases, a seismic isolator 202 includes one viscous damper 404 and one elastic support assembly 406. The elastic support assemblies 406 serve to decouple the natural frequency of the RES from the reactor building and attenuate transmitted motions at the RES internal structural frequencies. The isolation dampers 404 are passive devices and are typically only load bearing during seismic events. When at rest, they provide relatively easy access to the damper fluid which can be inspected, sampled, and serviced, and without a need for jacking the supported structure. Depending on the application, the dampers work with different viscous fluids. In applications where environmental conditions include radiation, the resistance of the damper fluid is a factor in determining the appropriate chemical composition. Tests have demonstrated that the bituminous and polybutene based fluids remain functional to the required level of radiation while the silicone oil-based fluid stiffens and its damping decreases. Therefore, in some cases, the viscous dampers 404 are filled with a bituminous and/or polybutene base fluid.

The use of helical coil springs in an elastic support assembly 406 and viscous dampers 404 that provide velocity proportional damping force means the dynamic response to earthquake shaking can be modeled efficiently and with minimal uncertainty for design basis ground motions. Tests on isolation units have demonstrated good correlation between measurement and numerical models using ideal springs and dampers. The elastic support assemblies 406 may include a top plate 408, a bottom plate 410, and one or more helical coil springs 412 disposed therebetween. The helical coil springs 412 can be selected to have different spring constants, different lengths, and different sizes. The clastic support assemblies 406, or some of the elastic support assemblies, may alternatively have different sized springs, or may even employ smaller springs inside larger springs.

In some embodiments, the elastic support assemblies 406 and the viscous dampers 404 may be combined into a single unit and the unit may include a top plate that is coupled to both the helical coil springs and the piston, along with a bottom plate that is coupled to the helical coil springs and the housing that holds the viscous fluid.

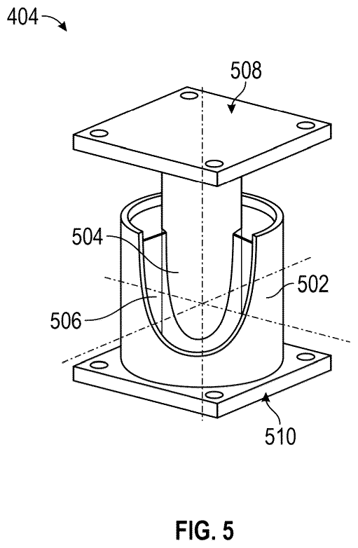

FIG. 5 illustrates a viscous damper 404, according to some embodiments. The viscous damper may include a housing 502 with a piston 504 disposed within the housing 502. The housing 502 may further include damping fluid, such as a bituminous and/or polybutene base fluids as discussed above. The piston 504 may be coupled to a top plate 508, which may be coupled to the MIRSS component. The housing may further have a bottom plate 510, which may be coupled to the reactor building basemat. The viscous damper 404 provides six degrees of freedom for the piston 504 within the housing 502, and the motion of the piston is dampened by the damping fluid 506 with the housing. The viscous damper 404 dissipates energy and reduces the amplitude of vibrations or oscillations caused by seismic events. As the piston 504 moves through the damping fluid 506, the damping fluid 506 provides resistance to the motion of the piston 504 proportional to the velocity of the piston motion. The resistance force generated by the viscous fluid opposes the motion of the piston, and hence the motion imparted to the structure to which the piston is coupled is attenuated and dissipated, which in this case, is the MIRSS. The result is that the mechanical energy imparted to the viscous damper is converted into heat energy within the fluid. The viscous dampers 404 are effective across a wide range of frequencies, making them especially suitable for use in seismic isolators when used to isolate a nuclear reactor and its components from seismic events.

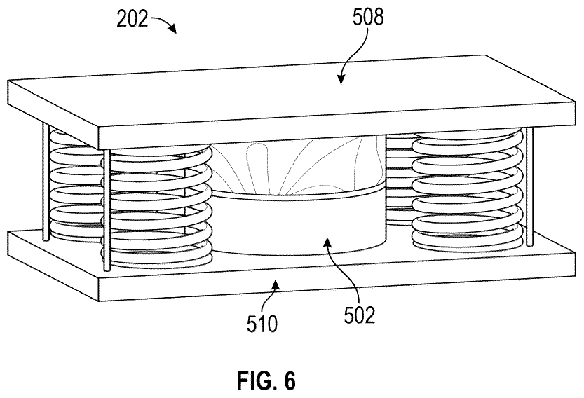

FIG. 6 illustrates a seismic isolator 202 in which the viscous damper 404 and elastic support assembly 406 are incorporated into a single unit. For example, a housing 502 may contain a piston and the viscous fluid. The piston may be coupled to a top plate 508 and the housing may be coupled to a bottom plate 510. A plurality of springs, 412, may be coupled to both the top plate 508 and the bottom plate 510. The seismic isolator 202 can thus be configured to attenuate three-dimensional motion and dissipate the kinetic energy, thus isolating the nuclear reactor from the motion of the reactor building and/or the basemat that supports the nuclear reactor. In some cases, the clastic support assemblies 406 use one or more helical coil springs.

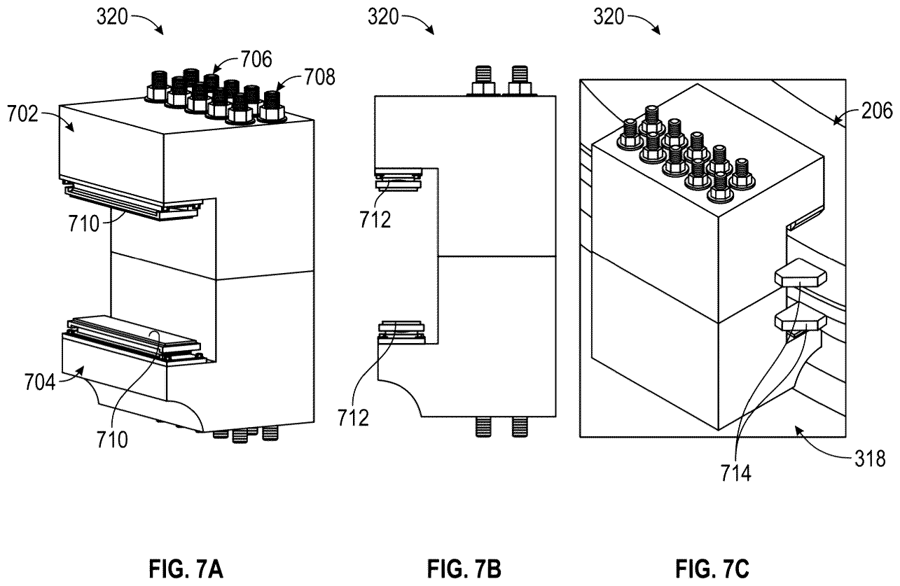

FIGS. 7A, 7B, and 7C illustrate a reactor support assembly block 320, with FIG. 7C illustrating the reactor support assembly block coupled to a MIRSS 318 and reactor head 206. In many embodiments, the RES interfaces with the reactor building at the seismic isolation system that transfers loads in both the vertical and lateral directions. In some instances, the top plate of the SIS is bolted to the modular integrated reactor support structure. In some cases, radial thermal growth of the RH and GV flange is accommodated without substantially inducing thermal stresses by arranging the MIRSS to support the RH through the reactor support assembly blocks 320. The reactor support assembly blocks 320 may be equally spaced around the circumference of the reactor head 206, and may include 10, 12, 18, 24, 36, or more blocks equally spaced around the circumference of the reactor head 206.

According to some embodiments, the reactor support assembly blocks 320 include an upper portion 702 and a lower portion 704 coupled to the upper portion 702. The upper potion 7802 and lower portion 704 may have holes formed therethrough that can be used for bolts 706 to pass therethrough to couple the upper portion 702 and the lower portion 704 together. In some examples, the bolts 706 may be integrated to the MIRSS 318, such as by being integrally formed therewith, or may simply pass through holes formed in the MIRSS 318. To assemble the blocks 320, the lower portion may be placed over the bolts 706 extending upwardly from the MIRSS 318. In some cases, the reactor head 206, and in some cases a mounting flange of the RV and/or GV, is then placed into position and may rest, at least partially, on the lower portion 704 of the blocks 320. The upper portion 702 may then be positioned onto the bolts 706 and secured with nuts 708.

In some cases, each block 320 provides resistance to vertical and tangential motions while accommodating radial expansion of the reactor head 206 by using oil-embedded bearing plates 710. The bearing plates allow the reactor head 206 to expand radially by sliding over the bearing plates 710. Of course, other types of bearing plates may be used, and they need not be oil-embedded plates, but could use other types of friction reducing techniques.

The blocks 320 may also include a cylindrical joint 712, which may be one or more cylindrical bearings, which may be used to accommodate head static deflection of the reactor head 206 due to gravitational loads. One or more gussets 714 may be affixed to the reactor head 206, such as by welding. The gussets 714, by being affixed to the reactor head, and thus move with the reactor head 206, provide a tight clearance for lateral load transfer between the reactor head 206 and the MIRSS 318. The gussets 714 further limit rotational movement of the reactor head 206 as it undergoes thermal expansion and contraction. Of course, the gussets 714 could be replaced with other suitable interfering structure that allows thermal expansion and contraction of the reactor head 206 while limiting rotational movement. For example, in place of gussets 714, the interfering structure may include a keyed structure, a rail, a boss, or other type of interlocking feature. The structure could be formed integrally with the reactor head 206 or could be coupled to the reactor head during installation. Similarly, the interfering structure could be a machined-out portion of the reactor head (e.g., a rectangular cutout along the perimeter of the reactor head) into which the block 320 slides to provide the advantages and benefits described herein.

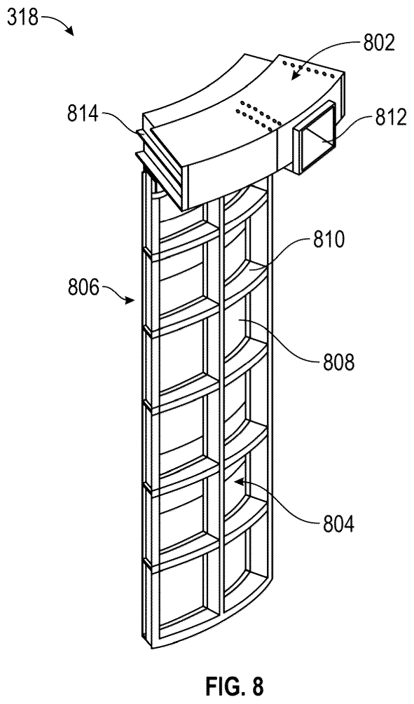

FIG. 8 illustrates a perspective view of a MIRSS component 318. According to some embodiments, the modular integrated reactor support system includes a plurality of segments, such as the one illustrated in FIG. 8. The component 318 may include an upper section 802 and a vertical section 804 depending downwardly below the upper section 802. The vertical section 804 may have a concave inner surface 806 that is concave about a vertical axis. Practically speaking, the vertical axis is generally aligned with the vertical axis of the reactor vessel. In this way, the vertical section 804 has a radius of curvature that is about equal to its radial distance from the central axis of the reactor vessel. An outer surface 808 is spaced from the concave inner surface by a wall thickness. In some cases, the outer surface 808 is spaced apart from the concave inner surface to form a hollow chamber therebetween. In some cases, the vertical section 804 may have ribs 810 attached thereto that may be used for mounting, to increase stiffness, or to increase strength.

The upper section 802 may include a duct port 812 that allows communication between an area adjacent the guard vessel and the ambient atmosphere. For instance, the duct port 812 may provide a passageway through the upper section 802 to an annular space inside of the concave inner surface 806 around the GV. The air flow may be forced, such as by incorporating fans, compressors, or a combination. In some cases, the duct port 812 allows heat dissipation from the seismic isolators 202 and may additionally cooperate with the passive emergency reactor cooling system to dissipate decay heat from the reactor.

In some embodiments, there may be 8, 9, 12, 18 or more MIRSS components 318 that may be coupled together to provide a support around the reactor head. The upper section 802 may have side walls that include cooperating protrusions 814 and grooves (not shown). The grooves and protrusions 814 may be provided to aid with alignment of adjacent MIRSS components 318 so that they may be coupled together, which may be accomplished through any suitable coupling technique, such as bolting, welding, or another suitable technique.

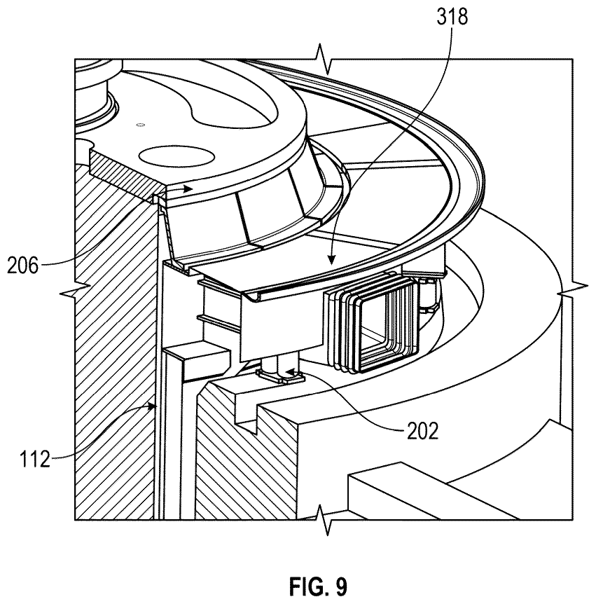

FIG. 9 provides a further illustration of the MIRSS component 318 and the seismic isolator 202. As described herein, the MIRSS components 318 support the reactor head with accompanying RES 112, and transfer the load from the reactor head 206, through the reactor support assembly blocks 320, through the MIRSS components 318, through the seismic isolators 202 and to the basemat of the reactor building 102.

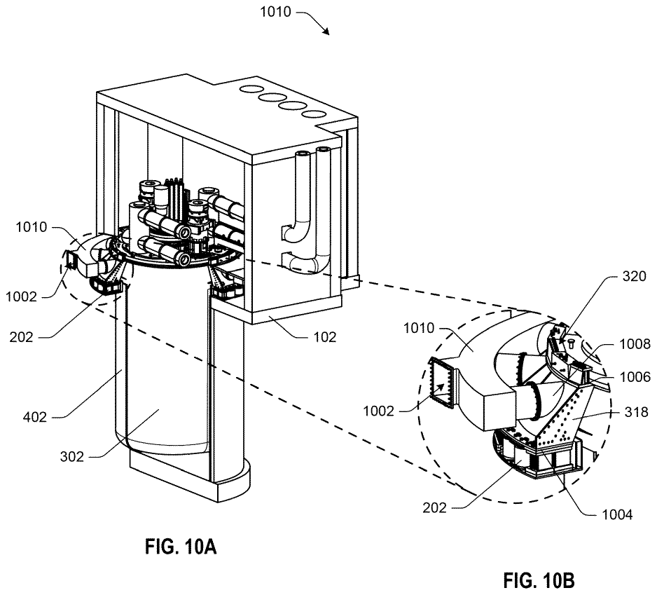

FIG. 10A illustrates a partial cutaway view showing the nuclear reactor and its mounting configuration, and FIG. 10B illustrates a closeup view of some of the components of the modular integrated reactor support structure (MIRSS) 318 including an air-cooling manifold outlet 1002, in accordance with some embodiments in accordance with some embodiments. The reactor building 102 is typically reinforced concrete that is configured to receive the weight of the reactor and transfer the load to the ground. The interface of the reactor to the reactor building 102 is through the seismic isolators 202 that attenuate and dampen motion of the reactor building 102 from being transferred to the nuclear reactor.

In some embodiments, the MIRSS components 318 have a bottom surface 1004 that rests upon the seismic isolators 202. The MIRSS components 318 may also have a top surface 1006 upon which the GV 304 and RV 302 rest upon. That is, the GV 304 and the RV 302 may hang from the MIRSS components 318. The MIRSS components 318 may define a hollow interior void through which air may circulate and enter and/or exit through a port 1008 formed into each of the MIRSS components 318. The ports 1008 may be coupled to a reactor air cooling manifold 1010 which may have one or more manifold outlets 1002 to help circulate cooling air around the RV 302 and/or the GV 304.

As described in relation to embodiments herein, the RV 302, GV 304, and optionally the reactor vessel head may be secured by reactor support assembly blocks 320.

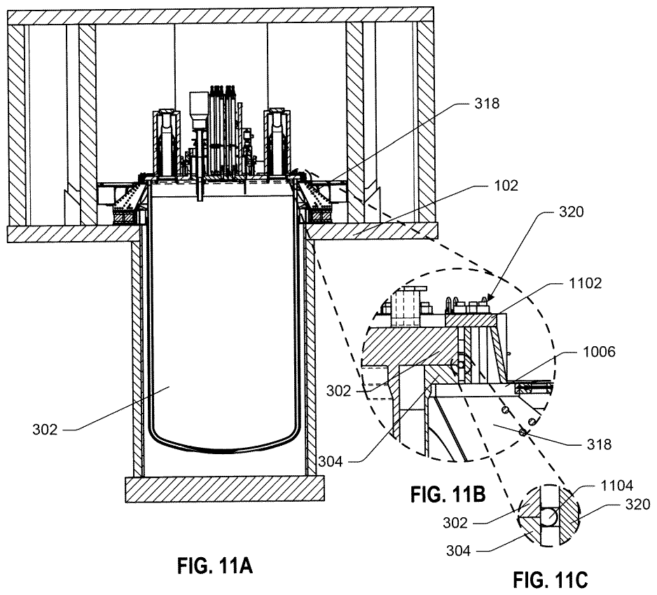

With reference to FIGS. 11A and 11B, the reactor support assembly blocks 320 are further illustrated. The MIRSS components 318 may have an upper surface 1006 and the GV 304 has a flange that rests on the upper surface 1006 of the MIRSS component 318. The RV 302 has a similar flange that sits on the GV 304. The reactor support assembly block 320 can be coupled to the upper surface 1006 of the MIRSS components 318 to restrain the RV 302 and the GV 304 from lateral and vertical motion. In some cases, the reactor support assembly block 320 has a top plate 1102 the constrains the RV 302 and the GV from vertical displacement. In some cases, the top plate 1102 is spaced above the RV 302 a set distance to allow a small degree of motion, such as from expansion and contraction of the RV 302. Similarly, the reactor support assembly block 320 may be spaced laterally away from the RV 302 and GV 304 a distance to allow for horizontal displacement, which may also be due to thermal expansion. The top plate 1102 may be secured to the reactor support assembly block 320 through any suitable coupling mechanism, such as by bolts, welding, clamps, or some other permanent or removable coupling structure or technique. As shown, the reactor support assembly block 320 may be coupled to the top surface 1006 of the MIRSS components 318 through any suitable mechanism or technique.

As described with any of the embodiments herein, the reactor support assembly blocks 320 may be spaced around the periphery of the RV 302 and the GV 304 at any desirable distance to provide a support thereto. The MIRSS components 318 sit upon the seismic isolators 202, which are supported by the reactor building 102. Thus, the gravitational load of the RV 302, the GV 304, and all the structures, assemblies, and components carried by the RV 302 and the GV 304 is transferred to the reactor support assembly blocks 320, to the MIRSS components 318, to the seismic isolators 202, to the reactor building 102 foundation, and then to the earth.

FIG. 11C illustrates a close-up view of the seal between the reactor vessel 302 and the guard vessel 304, in accordance with some embodiments, the RV 302 and GV 304 may be in surface contact with one another at their respective flanges that rest on the MIRSS component. At the interface between the RV 302 and GV 304, a seal 1104, such as an omega seal in some cases, may be used to provide a tight seal against gaps and movement. In some cases, the seal 1104 is configured to compress and conform to the interface between the RV 302 and the GV 304 to inhibit any leakage from the interface.

With the disclosed and described embodiments that provide a common load path for the RV, GV, and all the structures, systems, and components supported thereby, the entire reactor is seismically isolated. This has become increasingly important with the advent of nuclear reactors that operate at relatively low pressure and high temperatures. These types of reactors require far less structural steel and concrete than typical reactors that operate at pressures well above ambient, which creates a challenge for structural strength of the system, especially during seismic events. With the lack of pressure within the reactor vessel, it may be fabricated with less material, which tends to reduce its stiffness and allows flexing in response to stress. In addition, fast spectrum reactors are highly sensitive to differential motion between fuel assemblies as well as between fuel assemblies and reactivity modification devices.

This issue is exacerbated because many reactors have relatively large components, such as pumps, a reactor core, and heat exchangers within a single reactor vessel, which need not be as robust or as stiff as prior reactors that operated at higher pressures. In prior reactors, seismic isolation was a concern, but was addressed by seismically isolating the entire reactor building. Even so, seismic isolation was typically only done in a horizontal direction without any regard to vertical displacement of the reactor building. The described embodiments provide for systems and methods that seismically isolate the critical infrastructure and equipment in three-dimensions. Moreover, by providing seismic isolation to the critical equipment, the result is that both the reactor and secondary containment structures are both seismically isolated in three-dimensions. The further result is an efficient isolation of the entire nuclear reactor vessel along with the reactor core and reactor internals through a simplified seismic isolator and the load path of the entire nuclear reactor vessel is supported through the seismic isolator and to the basemat of the reactor building. Moreover, the described system can be fabricated in a manufacturing facility and assembled on site.

In some embodiments, the reactor vessel hangs from the reactor head. Therefore, the reactor head supports not only the reactor vessel and the primary coolant inventory, but also all the reactor internals, such as the core, the core assemblies, the in-vessel transfer machine, the intermediate heat exchangers, the primary coolant pumps, the in-vessel storage, along with other reactor internal components. Consequently, as the reactor head moves in response to seismic events, the entire contents of the reactor vessel, by virtue of being suspended from the reactor head, also experience seismic disturbance. Through the systems and methods described herein, the load path of the reactor head, the reactor vessel, and all the reactor internals, is commonly supported by the MIRSS components, including the seismic isolators, which transfer the load to the reactor building basemat. Consequently, any seismic motion of the reactor building is not transferred to the nuclear reactor, but rather, is attenuated and dissipated by the seismic isolators. Through modeling and testing, it has been shown that the systems and methods described herein attenuate the seismic amplitude and dissipate the kinetic energy up to 95% or more, thus resulting in a stable and predictable reactivity even during design basis and beyond design basis seismic events.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected”, or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components, and/or wirelessly interactable, and/or wirelessly interacting components, and/or logically interacting, and/or logically interactable components.

In some instances, one or more components may be referred to herein as “configured to,” “configured by,” “configurable to,” “operable/operative to,” “adapted/adaptable,” “able to,” “conformable/conformed to,” etc. Those skilled in the art will recognize that such terms (e.g. “configured to”) can generally encompass active-state components and/or inactive-state components and/or standby-state components, unless context requires otherwise.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A seismically isolated nuclear reactor, comprising:
a reactor head;
a reactor vessel coupled to, and hanging from, the reactor head;
a reactor support coupled to a periphery of the reactor head; and
a plurality of seismic isolators located under the reactor support, and further coupled to a basemat of a reactor building, wherein the plurality of seismic isolators are configured to cooperate to isolate the reactor head from seismic events.

2. The seismically isolated nuclear reactor of claim 1, wherein the reactor support comprises a plurality of arc-shaped components that are coupled to form a ring around the reactor head.

3. The seismically isolated nuclear reactor of claim 1, wherein at least some of the plurality of seismic isolators comprise viscous dampers, and wherein at least some of the plurality of seismic isolators comprise spring loaded assemblies.

4. The seismically isolated nuclear reactor of claim 3, wherein at least some of the plurality of seismic isolators comprise viscous dampers and spring loaded assemblies.

5. The seismically isolated nuclear reactor of claim 1, wherein the seismic isolators are configured to provide three-dimensional isolation to the nuclear reactor.

6. The seismically isolated nuclear reactor of claim 1, further comprising a plurality of support blocks, each of the plurality of support blocks coupled to the reactor support and engaging with the reactor head and configured to secure the reactor head to the support blocks.

7. The seismically isolated nuclear reactor of claim 6, wherein individual ones of the plurality of support blocks include a bearing plate upon which the reactor head rests.

8. The seismically isolated nuclear reactor of claim 6, wherein individual ones of the plurality of support blocks include a cylindrical bearing configured to allow thermal expansion of the reactor head.

9. The seismically isolated nuclear reactor of claim 6, further comprising interfering structure coupled to the reactor head, the interfering structure positioned such that it is disposed on both sides of a support block when the support block is engaged with the reactor head, the interfering structure configured to limit rotation motion of the reactor head relative to the support blocks.

10. The seismically isolated nuclear reactor of claim 1, wherein the reactor support comprises a plurality of modular supports configured to be coupled together to form a ring around the reactor vessel and reactor head.

11. The seismically isolated nuclear reactor of claim 10, wherein the reactor support further comprises a port configured to allow ambient air to pass through the reactor support to provide cooling air to an outside surface of the nuclear reactor.

12. The seismically isolated nuclear reactor of claim 10, wherein the reactor support further comprises hollow chambers disposed vertically downward from the ring.

13. The seismically isolated nuclear reactor of claim 12, wherein the hollow chambers are configured to carry radiation shielding material.

14. The seismically isolated nuclear reactor of claim 1, wherein a load path of the reactor vessel is transferred to the reactor head, and then to the reactor support, and then to the seismic isolators, and then to the basemat of the reactor building.

15. The seismically isolated nuclear reactor of claim 1, wherein at least some of the seismic isolators further comprise bituminous and/or polybutene base viscous fluid.

16. A modular reactor seismic system, comprising:
a support block having an upper section and a lower section and a gap sized to capture a reactor head of a nuclear reactor therein, the support block having a lower surface;
a support structure coupled to a lower surface of the support block, the support structure having an arc-shape and configured to extend at least partially around a circumference of the reactor head; and
a three-dimensional seismic isolator located under at least a portion of the support structure, the three-dimensional seismic isolator coupled to the support structure and further coupled to a floor and configured to attenuate and dissipate motion of the floor.

17. The modular reactor seismic system as in claim 16, wherein the support structure is coupled to a plurality of adjacent support structures such that the plurality of adjacent support structures forms a ring.

18. The modular reactor seismic system as in claim 17, further comprising a plurality of the support blocks coupled to the ring.

19. The modular reactor seismic system as in claim 17, further comprising a plurality of the seismic isolators positioned underneath the ring and configured to support the weight of the ring.

20. The modular reactor seismic system as in claim 16, wherein the three-dimensional seismic isolator comprises a viscous damper and an elastic support assembly.
